(19) United States
(12) Patent Application Publication
(10) Pub. No.: US 2007/0200357 A1
(43) Pub. Date: Aug. 30, 2007

(54) MOTOR VEHICLE DOOR LATCH

(75) Inventors: Volker WESTERWICK, Bochum (DE); Dirk HANISCH, Cologne (DE); Holger SCHIFFER, Meerrbusch (DE)

Correspondence Address: MATTHIAS SCHOLL, 14781 MEMORIAL DRIVE, SUITE 1319, HOUSTON, TX, 77079, US

(73) Assignee: KIEKERT AKTIENGESELLSCHAFT, Heiligenhaus (DE)

(21) Appl. No.: 11/673,565

(22) Filed: Feb. 10, 2007

(30) Foreign Application Priority Data
Feb. 10, 2006 (DE) 10 2006 006 443

(51) Int. Cl. E05C 3/06

(52) U.S. Cl. 292/201

(57) ABSTRACT

Taught is a motor vehicle door latch with a locking mechanism (1, 2) comprising a catch (1) and a pawl (2), said locking mechanism (1, 2) being capable of being moved along at least a first pathway and a second pathway; and at least one damping element (9), said damping element having at least a first damper constant and a second damper constant; wherein said damping element (9) is capable of damping a movement of said locking mechanism (1, 2) along said first pathway with said first damper constant; and said damping element (9) is capable of damping a movement of said locking mechanism (1, 2) along said second pathway with said second damper constant.

### CROSS-REFERENCE TO RELATED APPLICATIONS

Pursuant to 35 U.S.C §119 and the Paris Convention Treaty, this application claims the benefit of German Patent Application No. DE 10 2006 006 443 filed Feb. 10, 2006, the contents of which are incorporated herein by reference.

### BACKGROUND OF THE INVENTION

1. Field of the invention

The invention relates to a motor vehicle door latch with a locking mechanism comprising a catch and pawl and at least one damping element for the locking mechanism.

2. Description of the Related Art

A motor vehicle door latch with a locking mechanism comprising a catch and pawl is known in the art and described, for example, in UK Patent Application Publication No. GB 2 321 928 A. A damping stop for the catch is also known and described, for example, in German Patent Application Publication No. DE 103 20 457 A1. In addition, sound damping devices for door latches that are disposed between a catch and a pawl are known and described, for instance in DE 102 01 367 A1 or also DE 100 36 847 A1.

The state of the art is not fully satisfactory, however, as rubber dampers used in most cases do not always guarantee that the pawl engages securely in the catch. The generated noise also still presents a problem. The invention aims to remedy this situation.

The invention is based on the technical problem of improving a motor vehicle door latch in such a way that a reliably-functioning interaction is guaranteed between the pawl and the catch while keeping the noise to a minimum.

### SUMMARY OF THE INVENTION

In order to solve this technical problem, the invention teaches a motor vehicle door latch comprising a damping element which acts with at least two different damping constants on the locking mechanism, depending on the orientation of the catch along its closing path. In other words, the damping element provides two or more different damping rates for the locking mechanism being is closed along its closing path.

In this context it is advantageous if the damping element allows for an undampened movement of the locking mechanism at the beginning of its closing path. In most cases the movement of the locking mechanism must not be dampened until the locking mechanism has reached a certain latching position. In this way it is ensured that under all circumstances the pawl engages properly and correctly in a primary position (or first position) and that, as a result, a certain closing position of the locking mechanism is reached in all cases at which the mechanism can no longer be accidentally opened. Only after this position has been reached and during a continued movement along the closing path does the damping element come into effect.

In this way it is prevented that in case of excess damping at the beginning of the clothing path, the pawl does not correctly engage in the primary position of the catch and that the catch is so to speak “missed”. This is a clear improvement over conventional latches. This is also of special significance if the catch is in its so-called “overtravel position” on the other side of the primary position and returns back from that position. In most cases the overtravel position of the catch is assumed against the force of an additional damping element, returning back the catch into the primary position and/or the first position.

Depending on how quickly the catch moves during this process (assisted by additional spring forces moving the catch into its “open” position), it may happen that the catch has already moved past the pawl, before it has engaged in the primary position. In order to avoid this under all circumstances, the invention teaches that the damping element only enter into a dampened engagement with the closing path of the locking mechanism once a catch position—in most cases the primary position—has been reached. The damping element then ensures a further dampened engagement of the pawl in the primary position and that a “hard” mechanical stop and noises associated therewith are avoided.

The end of the closing path of the locking mechanism is generally not limited by the damping element. Although the damping element could in principle also function as an end stop, the invention teaches an end stop independent from the damping element wherein the end stop by itself mechanically limits the closing path of the locking mechanism. In this way it is ensured that in the end position (the position at the end of the closing path) no potential counter-forces produced by the damping element act between the pawl and the catch.

The aforementioned end stop can generally be separate from the locking mechanism. Alternatively, or in addition, the end stop can, however, also constitute a part of the locking mechanism. In this context it is advantageous if the end stop is designed as an extension arm of the pawl, coming into contact with the catch in order to limit the closing path.

In detail, the damping element may, therefore, be designed as a movement damper, thus ensuring that the movement of the locking mechanism is dampened during its movement phase and/or along the closing path. At the same time it is within the scope of the invention to operate with different damping constants during the dampened movement phase. It is for instance feasible to work with low damping constants at the beginning of the movement phase and for the damping rates to (progressively) increase thereafter. Naturally, other characteristics can also be selected.

Generally, the damping element comprises at least one damping fluid and/or is provided with at least one damping material. A plunger or a lever interacts with the damping fluid and/or the damping material, whose movement is dampened and which also interacts with the locking mechanism. In most cases the damping element actually acts on the pawl, although in certain embodiments of the invention the damping element acts additionally or alternatively on the catch. As soon as the pawl or the catch enters the range of action of the damping element, their closing movement is restrained and slowed down, depending on the stipulated selected damping constant. As a result, a hard mechanical impact at the end of the closing path is avoided as well as it is avoided that parts rub or scrape along each other. Noise is consequently reduced.

In order to facilitate undampened movement at the start of the closing path of the locking mechanism, it is advantageous if the damping element is located at a distance to the pawl corresponding to an empty path of the locking mechanism. The empty path is part of the undampened movement. Consequently, it is automatically ensured that the damping element only interacts with the pawl or the locking mechanism when the pawl comes into contact with the plunger or the lever of the damping element, whose movement is in turn inhibited in the desired manner by the interaction with the damping fluid and/or the damping material.

As a result, a motor vehicle door latch is provided which, on one hand ensures a reliable functioning, in particular, when the pawl enters the primary position and which, on the other hand, provides perfect noise dampening.

This is mainly achieved as a result of the dampening element arranged at a distance to the pawl and being designed as a movement damper. In this context, highly viscous oil may be used as damping fluid or even gas, such as air. In this case, the plunger is designed as a piston immersing in an associated cylinder filled with fluid. It is also feasible that the plunger or the lever is designed as a displacement element rotating in the fluid, e.g. a propeller arranged on a shaft.

Alternatively, or in addition, a damping material may be used which is a (helical) spring or rubber spring element. This is for instance compressed with the aid of the plunger or the lever and provides in this way the desired damping characteristics. Depending on the latch type, different damping characteristics and consequently damping rates adapted to the function are feasible and are part of the scope of the invention.

### BRIEF DESCRIPTION OF THE DRAWINGS

The invention is described hereinbelow with reference to accompanying drawings, in which:

FIG. 1 shows a schematic view of the motor vehicle door latch of the invention; and

FIGS. 2a to 2c show a plan view the locking mechanism in various stages of operation.

### DETAILED DESCRIPTION OF THE INVENTION

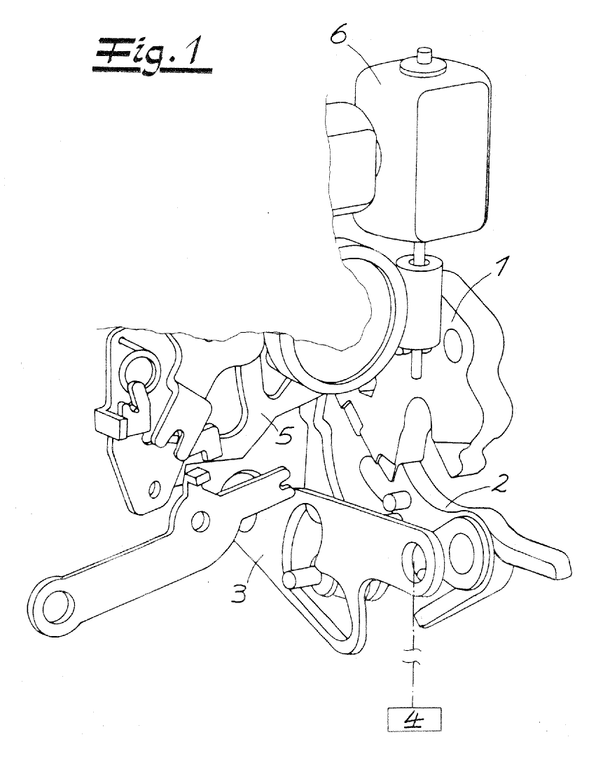

FIG. 1 shows a motor vehicle door latch with a locking mechanism 1, 2 comprising a catch 1 and a pawl 2. Also apparent from the figure is a release lever 3, disengaging the pawl 2, which release lever 3 can be connected to a handle 4.—The figure shows a partial view of a central locking lever 5, operated by a motor 6. Depending on the position of the central locking lever 5, i.e., “unlocked” or “locked,” the pawl 2 can or cannot be disengaged with the aid of the handle 4, respectively.

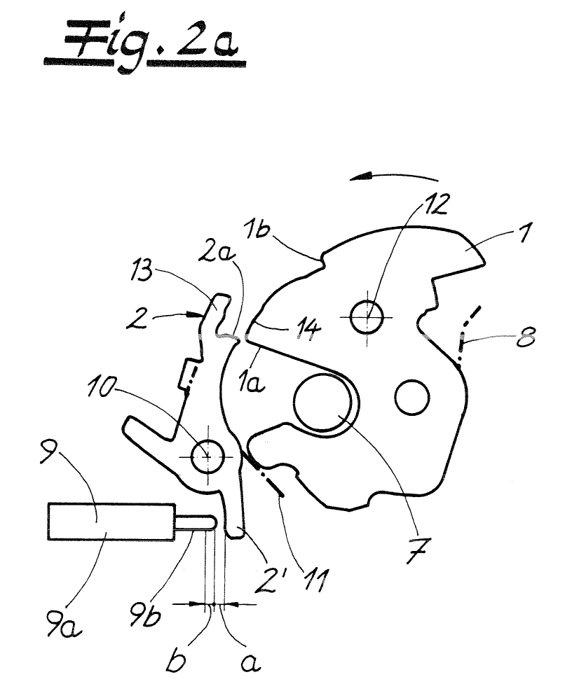

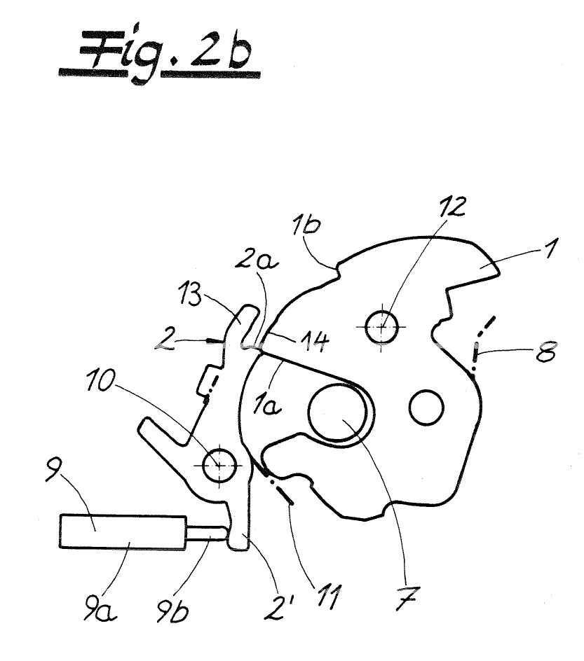

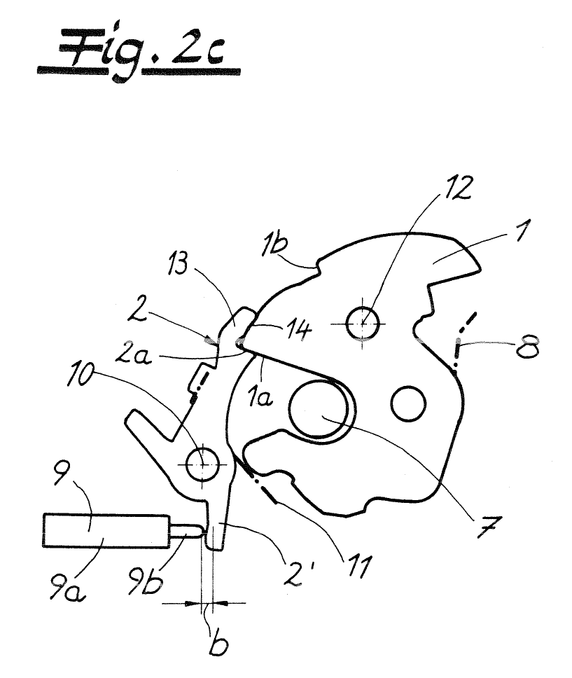

FIGS. 2a to 2c show the details of the locking mechanism 1, 2 interacting with a closing bolt 7. During the closing of an associated motor vehicle door, a lid or a similar device, the closing bolt 7 initially moves the catch 1 by turning clockwise around axis 12 to its overtravel position as indicated in FIG. 2a. As a result of being in this overtravel position, a gap in the direction of the circumference is visible between a primary position 1a and/or the associated stop surface and a blocking area 2a on the pawl 2.

A spring 8 for the catch 1 together with an overtravel stop, not explicitly shown in the figure, then ensures that the catch 1 is acted upon in the counterclockwise direction as shown by the arrow. During this reverse movement of the locking mechanism 1, 2 or of the catch 1 against the actual closing movement as a result of the catch 1 turning clockwise, it is important that the pawl 2 reliably engages with its blocking area 2a in the primary position 1a. In order to ensure this, a damping element 9 acts with at least two different damping constants on the locking mechanism 1, 2, said damping constants being dependent on the closing path of the locking mechanism 1, 2.

The damping element 9 acting solely, yet without limitation, on the pawl 2 in this embodiment allows for an undampened movement of the locking mechanism 1, 2 and/or the pawl 2 at the beginning of the closing path of the pawl 2. This undampened movement is achieved by the damper element 9 being arranged at a distance from an extension arm 2′ of the pawl 2. The damping element 9 comprises a housing 9a and a piston 9b immersed in said housing, displacing a damping fluid in the housing 9a as soon as it progressively immerses in the housing 9a—starting with the position shown in FIG. 2a and progressing toward the position shown in FIG. 2c.

The distance a between a front-sided end of the piston 9b and the extension arm 2′ of the pawl 2 ensures that in any case the damping element 9 does not come into a contact with the pawl 2 at the start of the closing path of the locking mechanism 1, 2 and/or the pawl 2 and that, as a result, the pawl 2 acted upon by the spring 11 carries out a clockwise movement around its axis 10. This is ensured by the spring 11 assigned to the pawl 2, respectively pretensioning the pawl 2 in the clockwise direction.

After the extension arm 2′ of the pawl 2 has carried out its undampened movement in the clockwise direction around the axis 10 according to the distance a and has reached the position shown in FIG. 2b, the blocking area 2a of the pawl 2 in contact with the primary position 1a, ensures that the catch 1 can no longer be turned counterclockwise around its axis 12—driven by the spring 8. This is followed by the dampened movement of the locking mechanism 1, 2 corresponding with a displacement path b of piston 9b of the damping element 9. During this displacement path b, the pawl 2 is reliably moved into the primary position finally reached in FIG. 2c. During this phase, the movement of the pawl 2 is attenuated.

As soon as the closing path of the locking mechanism 1, 2 or of the pawl 2 is completed, a mechanic end stop 13 ensures that the pawl 2 is not moved any further in the clockwise direction around its axis 10. This end stop 13 is designed as an extension arm 13 of the pawl 2. The extension arm 13 of the pawl 2 cooperates with a stop area 14 on the catch 1, extending between its primary position 1a and its first position 1b. In the position shown in FIG. 2c, the locking mechanism 1, 2 is completely closed, as the extension arm 13 is in contact with the contact area 14. The damping element 9 is no longer effective, as the piston 9b does no longer carry out any movement against the damping fluid.

When comparing FIGS. 2a and 2c, it is apparent that the distance a and the displacement path b follow each other directly. When the pawl 2 moves across the distance a the locking mechanism 1, 2 is not dampened, while during the displacement path b the damping element 9 is active. This results in two different damping constants with which the damping element 9 acts on the locking mechanism 1, 2, one damping constant while passing over the distance a (a damping constant of 0) and another damping constant while passing over the displacement path b (a damping constant dependant on the properties of the damping fluid and/or material in the housing 9a).

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. A motor vehicle door latch with a locking mechanism (1, 2) comprising a catch (1) and a pawl (2), said locking mechanism (1, 2) being capable of being moved along at least a first pathway and a second pathway; and at least one damping element (9), said damping element having at least a first damper constant and a second damper constant; wherein said damping element (9) is capable of damping a movement of said locking mechanism (1, 2) along said first pathway with said first damper constant; and said damping element (9) is capable of damping a movement of said locking mechanism (1, 2) along said second pathway with said second damper constant.

2. The latch of claim 1, wherein said first damper constant is about 0 allowing for an undampened movement of said locking mechanism (1, 2) along said first pathway.

3. The latch of claim 1, wherein said catch is capable of assuming a first latching position; and said damping element (9) is capable of damping said movement of said locking mechanism (1, 2) along said second pathway with said second damper constant once said catch has assumed said first latching position.

4. The latch of claim 1, further comprising a mechanical end stop (13), wherein said mechanical end stop (13) limits movement of said locking mechanism (1, 2) independently of said damping element (9) limiting movement of said locking mechanism (1, 2).

5. The latch of claim 5, wherein said end stop (13) is a part of said locking mechanism (1, 2), or said end stop (13) is not a part of said locking mechanism (1, 2).

6. The latch of claim 1, wherein said damping element (9) is a moving damper.

7. The latch of claim 6, wherein said damping element (9) is linear damper.

8. The latch of claim 1, wherein said damping element (9) comprises a plunger or a lever (9b); and at least one damping fluid and/or a damping material, said damping fluid and/or said damping material damping the movement of said plunger or said lever.

9. The latch of claim 1, wherein said damping element (9) acts on said pawl (2).

10. The latch of claim 1, wherein in a certain position of said catch (1) said pawl (2) is separated from the said damping element (9) by a distance a.

11. The latch of claim 1, comprising further a blocking area (2a), wherein said pawl (2) engages with said blocking area (2a) in a primary position (1a).

12. The latch of claim 1, wherein said pawl (2) comprises an extension arm (2′), said extension arm (2′) preventing the damping element from contacting the pawl (2) in a certain orientation of said catch (1).

13. The latch of claim 1, comprising further a spring (11), said spring (11) pretensioning said pawl (2) in the clockwise direction.

14. The latch of claim 1, comprising further a spring (8), said spring (8) ensuring that said catch (1) is acted upon in the counterclockwise direction.

15. The latch of claim 8, wherein said second damper constant is greater than zero and depends on damping properties of said damping fluid and/or said damping material.

16. A motor vehicle door latch with a locking mechanism (1, 2) comprising a catch (1) and a pawl (2); and at least one damping element (9), said damping element being capable of providing variable resistance against a movement of said catch and/or said pawl.

17. A motor vehicle door latch with a locking mechanism (1, 2) comprising a catch (1) and a pawl (2); said catch being rotatable around a first axis of rotation between an open position and a closed position, wherein said locking mechanism (1, 2) is acted upon by a counteracting force during a final portion of a rotating movement of said catch from said open position toward said closed position.

18. The latch of claim 17, wherein said locking mechanism (1, 2) is not acted upon by a counteracting force during an initial portion of a rotating movement of said catch from said open position toward said closed position.

19. The latch of claim 17, wherein said counteracting force is provided by a viscous fluid damper.

20. The latch of claim 19, wherein said viscous fluid damper acts on said pawl (2).
